(19) United States
(12) Patent Application Publication
(10) Pub. No.: US 2025/0085302 A1
(43) Pub. Date: Mar. 13, 2025

(54) Method for Executing a Chemical Workflow

(71) Applicant: Chemspeed Technologies AG, Fullinsdorf (CH)

(72) Inventors: Rolf Gueller, Herznach (CH); Markus Schindler, Ennetbürgen (CH); Mathias Cherbuin, Liestal (CH)

(21) Appl. No.: 18/563,962

(22) PCT Filed: May 24, 2022
(86) PCT No.: PCT/CH2022/050011

§ 371 Date: Nov. 24, 2023

(30) Foreign Application Priority Data
May 28, 2021 (CH) 00617/21

(51) Int. Cl. G01N 35/00; G01N 35/10

(52) U.S. Cl. CPC G01N 35/00871; G01N 35/0092; G01N 35/1072; G01N 2035/0091; G01N 2035/0094

(57) ABSTRACT

In a method for executing a chemical workflow, the workflow is processed step-by-step manually and/or in an automated manner. While it is being processed, the workflow is recorded by means of a recording device and the recording so created is by means of a computer evaluated and converted into instructions which comprise detailed working instructions for a laboratory worker or for at least one automated laboratory device, on the basis of which working instructions the recorded workflow can be repeated manually and/or in an automated manner or, based thereon, a modified workflow can be created.

### CROSS REFERENCE TO RELATED APPLICATIONS

This application is the United States national phase of International Patent Application No. PCT/CH2022/050011 filed May 24, 2022, and claims priority to Switzerland Patent Application No. 00617/21 filed May 28, 2021, the disclosures of which are hereby incorporated by reference in their entireties.

### BACKGROUND OF THE INVENTION

### Field of the Invention

The invention relates to a method for executing a chemical workflow.

### Description of Related Art

With the rapid development of digitalization it is increasingly the case that electronic recording/display technologies and data-processing methods are also finding their way into chemical laboratories and chemistry-related industries. It is today already standard practice for, for example, substances and their properties, as well as their availability in a laboratory or stockroom, to be stored and used in electronic data banks. In addition, nowadays the actual working instructions for chemical experiments and the production of chemical products, as well as the corresponding analyses and results, are also generally in electronic, that is to say digital, form. Also widespread is the use of methods and technologies where, for example, the working instructions for a chemical experiment or the production of a chemical product are no longer provided on paper, but are made available to the laboratory worker by means of electronic devices, such as, for example, a desktop or laptop PC, a tablet or smartphone or by means of smart glasses, and the laboratory worker then uses that electronic information to carry out his working steps manually, using an automated production device or using a combination of manual and automated steps. Increasing use is also being made of interactive systems in which, for example, a recording device records the devices in a laboratory, and even detects their position, and directly visualizes the information relevant to the laboratory worker, for example by means of smart glasses, as soon as it has visually captured the device. The laboratory worker can thus be guided through the working steps step-by-step, without needing to read and work through printed directions for that purpose. US 2019/0018694 A1 discloses a virtual laboratory assistance platform which is able to supply a laboratory worker with information necessary or helpful for carrying out a chemical experiment and, for example, is able to guide a user step-by-step through a scientific protocol and is also able to carry out electronic recording and protocolling of a workflow. It does not show how reproducible working instructions can be created.

The document CN 111659483 B discloses the planning, conversion into instructions and automatic execution of a chemical workflow. Instructions are in this case created by planning a workflow.

### SUMMARY OF THE INVENTION

The object of the invention is to provide a method of the generic kind which allows the automatic creation of detailed working instructions, on the basis of which the same workflow or, based thereon, a modified workflow can be repeated or executed manually and/or in an automated manner.

That problem underlying the invention is solved by the method according to the invention described herein. Advantageous embodiments and developments of the method according to the invention are subject matter of the dependent patent claims.

The core of the method according to the invention lies in the following: in a method for executing a chemical workflow, the workflow is processed step-by-step manually and/or in an automated manner. While it is being processed, the workflow is recorded by means of a recording device and the recording so created is by means of a computer evaluated and converted into instructions which comprise detailed working instructions for a laboratory worker and/or for at least one automated laboratory device, on the basis of which working instructions the recorded workflow can be repeated manually and/or in an automated manner or, based thereon, a modified workflow can be created.

The method according to the invention makes it possible, on the basis of an executed workflow, automatically to create detailed working instructions for manual and/or automated repetition of the workflow, or a customised workflow based thereon, in a simple way.

Advantageously, the recording device for recording the workflow is wearable and has augmented reality or mixed reality or virtual reality capabilities. The recording device advantageously has the capability to record the position and the movement of the recording device within a laboratory space in which the recorded workflow is being executed. Advantageously, a recording device is used which is equipped with a capability to detect objects and track objects within the laboratory space, there also being recorded positions and/or changes in the positions of objects in the laboratory space. As a result, the recording can be supplemented by information relating to objects used and the movements thereof.

Advantageously, sensor information, such as UV radiation and/or IR radiation and/or radioactive radiation and/or thermal radiation and/or radiation of other wavelengths and/or vibrations and/or contacts are recorded during the processing of the workflow. The recording can thus be further supplemented.

Advantageously, the sensor information is displayed superimposed on a visual image in a display device and/or presented or displayed via an information device in a laboratory space. As a result, for example, a laboratory worker is able to respond to the sensor information.

Advantageously, information recorded during the workflow is converted into customisable working instructions for a laboratory worker and/or for at least one automated laboratory device, on the basis of which working instructions the recorded workflow or a modified workflow based thereon can be processed.

Advantageously, the information which the laboratory worker needs in order to execute or record the converted workflow is communicated to the laboratory worker by means of a wearable display device, the information being displayed virtually so that it can be associated by the laboratory worker directly with the appropriate working step and/or with the laboratory device used for the working step, the displayed virtual information being superimposed on a real or virtually displayed laboratory space and/or on the laboratory devices located therein. This provides an easier overview for the laboratory worker.

Advantageously, prior to its being executed, the workflow is programmed in digital form and converted into instructions which comprise detailed working instructions for a laboratory worker and/or for at least one automated laboratory device, which working instructions are used for the manual and/or automated execution of the workflow.

Advantageously, during the execution of the previously programmed workflow, that workflow is displayed to a laboratory worker executing the workflow as step-by-step directions by means of a wearable display and recording device having augmented reality or mixed reality or virtual reality capabilities, the display and recording device being connected to a computer which controls the workflow.

Advantageously, video recordings are created, abstracted and displayed in abstracted form as working instructions superimposed on a working area visible to the laboratory worker in order to indicate to the laboratory worker the working steps that are to be carried out. The display is effected preferably by means of an augmented reality device.

Conveniently, by means of the display and recording device, individual steps of the working instructions, as well as information relating to laboratory aids, substances and materials to be used and physical conditions and hazards, are displayed directly superimposed on objects visible to the laboratory worker.

Advantageously, the display and recording device is equipped with sensors for detecting environmental conditions, and, by means of the wearable display and recording device, environmental conditions detected by the sensors are assigned as physical parameters to the visible objects and, in a converted form understandable for the laboratory worker, displayed and digitally protocolled.

Advantageously, a laboratory worker calls up existing working instructions, whereupon they are converted and sequenced into discrete working steps by an automatic system, after which those discrete working steps are converted into new working instructions or integrated into existing working instructions.

Advantageously, physical and/or chemical parameters captured by technical apparatus and devices used during the workflow are also digitally recorded.

Advantageously, during the execution of the workflow, inputs are entered in order to input parameters that differ from the working instructions or that are to be supplemented, there also being recorded a value specified by the working instructions as well as the input value of the parameter.

Advantageously, the chemical workflow is executed by remote control, in which case a remote partner has, via a network connection, access to all information available to a local laboratory worker and/or to at least one automated laboratory device as well as access to an image visually captured by the local laboratory worker and/or by the at least one automated laboratory device and is able to interact with the local laboratory worker and/or with the at least one automated laboratory system in order to direct the local laboratory worker and/or the at least one automated laboratory device and/or to enter inputs himself and/or to operate or control laboratory devices himself.

Advantageously, the remote partner effects the creation of the working instructions for the workflow, and the local laboratory worker and/or the at least one automated laboratory device executes the workflow using those working instructions and records that workflow during its execution.

Advantageously, existing working instructions in text form or an existing document containing working instructions in text form are detected by means of an automatic text recognition system and processed.

Conveniently, sensors for detecting UV radiation and/or IR radiation and/or radioactive radiation and/or thermal radiation and/or radiation of other wavelengths and/or vibrations and/or contacts are used.

Advantageously, if values captured by the sensors exceed/fall below defined limit values, then warning signals and/or working instructions to the wearable display and recording device and/or visual or acoustic warning systems are issued automatically.

Advantageously, individual working steps of the working instructions are displayed as graphic animations which demonstrate to a laboratory worker exactly what action he needs to take in a working step.

### BRIEF DESCRIPTION OF THE DRAWINGS

The invention is described in greater detail below with reference to exemplary embodiments shown in the drawings, wherein:

FIG. 1—shows a diagrammatic principle arrangement of a device for carrying out the method according to the invention;

FIG. 2—shows a diagrammatic representation of the digitalization of a laboratory;

FIG. 3—shows a sequence of the most important steps of the method according to the invention;

FIG. 4—shows a diagrammatic representation of an exemplary laboratory area (image seen in reality);

FIG. 5—shows artificially generated graphic information;

FIG. 6—shows a display of the artificially generated information superimposed over the real image by means of an augmented reality device;

FIG. 7—shows an example of graphic information displayed during the execution of a workflow; and

FIG. 8—shows a further example of such graphic information.

### DESCRIPTION OF THE INVENTION

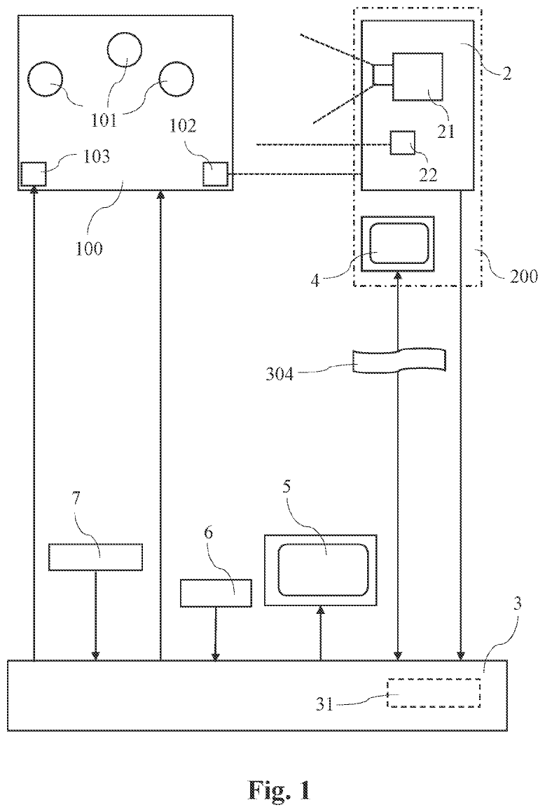

The arrangement shown diagrammatically in FIG. 1 comprises a laboratory space 100, a recording device 2, a computer 3, a display device 4, a monitor 5 and an input device 6.

In the laboratory space 100 there are located laboratory devices which are here symbolized by circles 101. Also present in the laboratory space 100 are various sensors which are here represented by a square 102. Also located in the laboratory space 100 is an information device 103 for visual or acoustic presentation of information.

The recording device 2 comprises a video camera 21 and various sensors which are here represented by a square symbol 22. The video camera 21 is directed towards the laboratory space 100 and captures the objects located therein and the movements thereof. The sensors 22 capture physical parameters of the environment, especially in the laboratory space 100 and the objects located therein. The recording device 2 carries out only the capture (and optionally digitalization) of the data from the video camera 21 and the sensors 22 and 102; the storage of that data takes place in the computer 3.

The display device 4 displays various information, especially working instructions, on a graphic display. The recording device 2 and the display device 4 are in practice advantageously combined to form a wearable recording and display device 200 and can advantageously be implemented by a wearable apparatus having augmented reality or mixed reality or virtual reality capabilities, for example the apparatus HoloLens® from Microsoft®.

FIG. 1 further shows a data bank 7 which contains the data of what are known as digital twins of the laboratory devices located in the laboratory space 100. The data bank 7 is connected to the computer 3, but can of course also be stored in the computer 3 itself.

A special feature of devices having augmented reality or mixed reality or virtual reality capabilities is that they are able to display artificially generated information directly superimposed on the real world (augmented reality or mixed reality) or in a virtual space (virtual reality). With the aid of digital twins and knowledge or detection of their position in the real and virtual space, the wearer of such devices can be presented with information so that the information is superimposed on real objects, points to those objects or even visually highlights those objects in order to make them better visible. If, for example, the focus is on a previously digitalized container it is possible to display, for example, what it contains and in what amounts, or the container can be highlighted in order to indicate that something can or should be done with it. In addition, the virtual display can also display things or situations which are not visible to the eye. For example, an object identified as dangerously hot by an IR camera present in the device can be highlighted with a bright colour in order to warn the wearer of the device of the risk of burning. Or, for example, moving parts, such as stirrers etc., in a container can also be shown as a superimposed animated moving image, even though they are not visible from the outside.

The computer 3 co-operates with the recording device 2, the display device 4 and the information device 103 in the laboratory space 100 and also controls the laboratory devices located in the laboratory space insofar as the latter are designed to be controlled by a computer. Furthermore, the computer 3 executes all the operations required in connection with the method according to the invention. Such operations include the storage of data captured by the recording device 2, the evaluation and processing of that data and the output of data and information to the display device 4 and the information device 103. The monitor 5 and the input device 6 serve as user interface. The computer 3 runs software 31 designed for evaluating and processing the data. The operating system and memory of the computer 3 are not shown in FIG. 1.

As preparation for the method according to the invention, a chemical laboratory or a corresponding production facility is first digitalized. The infrastructure (spaces, devices, and also substances, aids) are modelled and the individual elements are assigned properties and functions, and so for each individual element or object there is created what is known as a digital twin which represents that object in the virtual world and data structure.

FIG. 2 illustrates the digitalization of a laboratory.

In a first step 71, the laboratory space is simulated as a three-dimensional virtual object. This can be effected, for example, by modelling the space in a 3D program (CAD program). In an advantageous variant, the creation of the model can also be effected in a semi-automated or automated manner by the use of conventional 3D scanning methods (for example laser scanning) or photogrammetric methods. In the latter case the 3D model of the space is computed automatically by means of a specialised program on the basis of a large number of photographs taken from different positions in the space. Such methods are familiar to the person skilled in the art and are often used, for example, in architecture, archaeology and art history as a simple but highly accurate way of converting existing spaces, for example historic buildings and their interiors, into a 3D model. In addition, the movable elements of a laboratory (for example tools and aids, and also consumables or containers for substances stored in the laboratory, etc.) are created as a 3D model.

A subsequent step 72 consists of the assignment of functions and properties to the respective individual models or model parts. For example, a model of a pipette is assigned its properties (pipette volume, consumables, accuracy . . . ) and stored in a data bank.

In a third step 73, a three-dimensional model of the laboratory space and the laboratory devices contained therein (with the associated functions and properties) is created. In an advantageous configuration, the data for a laboratory object also contain directly the current position of the object within the model of the laboratory space, that is to say the pipette mentioned in the example would have a known, clearly defined current position in the 3D model of the laboratory.

Also, for example, a model of a laboratory device, such as, for example, a weighing scales or an analysis apparatus, is correspondingly assigned its position and properties, which are stored. The task steps of the workflow for which the device/the object is suitable are also stored. In the case of the above-mentioned pipette, for example, the object would also be assigned the property “suitable for manual fluid transfer in the range up to 1 ml with an accuracy of +/−0.01 ml”. That means that for each real object in the laboratory space there also exists a corresponding image in the virtual world, what is known as a digital or virtual twin. The totality of data so created is stored in the data bank 7 and is then available for the method according to the invention.

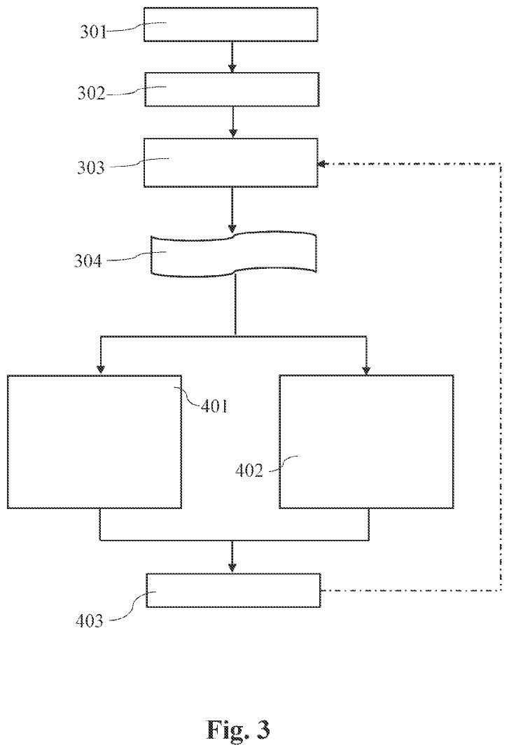

FIG. 3 shows the flow of the method according to the invention simplified as a sequence of different phases and working steps. Here a workflow executed in reality is used to generate working instructions on the basis of which the same workflow can be repeated in a guided manner or on the basis of which modified workflows can be created (and later processed in a guided manner).

In a step 301 of an instruction creation phase, a laboratory worker executes a desired chemical workflow (for example an experiment or a test reaction) more or less freely (or in accordance with, for example, written directions) and records his working steps by means of the recording device 2. The laboratory worker can enter inputs (for example which step he is performing with which device and which parameters). On the other hand, however, information delivered by connected apparatus are also automatically recorded.

In a step 302, the recorded workflow is evaluated by the software 31 in the computer 3 and, with reference to the digital twins of the objects in the laboratory space 100 that are stored in the data bank 7, converted into a sequence of executable working instructions 304. The result is step-by-step directions which, by means of the display device 4, can be displayed step-by-step as a sequence of individual working steps, all the individual working steps being exactly defined (for example, what is to be done when and how and using which devices and tools) and parameterised.

In a further optional step 303, if required the recorded workflow or the working instructions created therefrom are customised.

The working instructions 304 thus created can then be used in an execution phase for manual (box 401) or automated (box 402) repeated processing of the workflow, the processed workflow likewise being recorded again.

In a step 403, the storage of the executed workflow and its results etc., as well as the evaluation and analysis of the recorded workflow, is carried out. On the basis thereof, the further optional step 303 can then be performed, if required, for further executions of the workflow.

Advantageously, the user or laboratory worker can also base his workflow on existing workflows and customise them. It is also possible for existing documents (for example earlier protocols and working instructions), which have been captured electronically, to be converted by means of artificial intelligence or an automated system into a format usable by the system according to the invention and for those converted working instructions to be sequenced into individual working steps which can, in turn, then be used as individual working steps in the new workflow. In this case it is also advantageous to use text recognition systems which convert, for example, scanned, photographed or otherwise visually captured working directions into a machine-compatible format.

In the instructions creation phase, a workflow is recorded and converted for later further use. In this phase a laboratory worker executes a workflow in the real laboratory using the real laboratory devices and substances. While so doing he uses the recording device 2, which records his activities (for example by filming the actions). In an advantageous configuration, that recording device is part of the augmented reality or mixed reality apparatus 200 which is also able to display or superimpose additional information on the recorded image or video. In a further advantageous configuration, the recording device 2 detects and/or tracks the recorded elements and their assignment to the corresponding digital twins autonomously and displays the information relevant to the laboratory worker on the display of the display device 4. The detection of the objects can advantageously be effected by means of object recognition software in the software 31 or bar codes or QR codes (which are then, for example, scanned and detected by the camera 21 of the recording device 2). The identification and detection of the position and alignment in the space can also be effected by means of a kind of multi-point identification system: here four or more reference dots, for example made of a reflective, readily visible material, are mounted on each object in the form of a three-dimensional pattern so that their pattern and alignment can be detected by a camera (here advantageously the above-mentioned video camera 21 built into the recording device 2) and the identity, position and spatial alignment can be unambiguously detected. This is a method that is known and established, for example, in the case of many virtual reality applications (for example, what are known as “full body virtual games”). It is also possible to detect and track the identity and position of the objects in the laboratory space by means of suitable sensors and markers (for example RFI chips) attached to the objects.

In an especially advantageous configuration, the recording device 2 together with the display device 4 consists of an augmented reality or mixed reality apparatus wearable on the head like a pair of glasses, such as, for example, the commercially available Microsoft® Hololens®, which is able to project information directly into the eye of the wearer so that that information is displayed, like a hologram, superimposed on the image perceived in reality.

In the case of manual processing of the workflow (box 401) the previously created working instructions 304 are made available to a laboratory worker so that he can be guided through the processing of the workflow on the basis of those working instructions. Advantageously, for displaying the working instructions there is used a display device in which, on the one hand, the real working environment (laboratory space or working area with all devices, tools, aids, materials, . . . ) is visible or displayed. At the same time, however, that display is overlaid graphically with additional information which is superimposed on the real objects. This can be implemented, for example, using what are known as augmented reality devices, such as, for example, the Microsoft® HoloLens®. It is also possible, however, to use a correspondingly suitable smartphone, a tablet computer or the like. FIG. 1 shows in symbolic form how the working instructions 304 are output by the computer 3 to the display device 4.

As an alternative to manual execution of the workflow (box 401), the workflow can also be executed by at least one automated laboratory device (box 402). In both cases the executed workflow is recorded. A prerequisite for this is, of course, that the working instructions 304 are in a form that the at least one automated laboratory device is able to process.

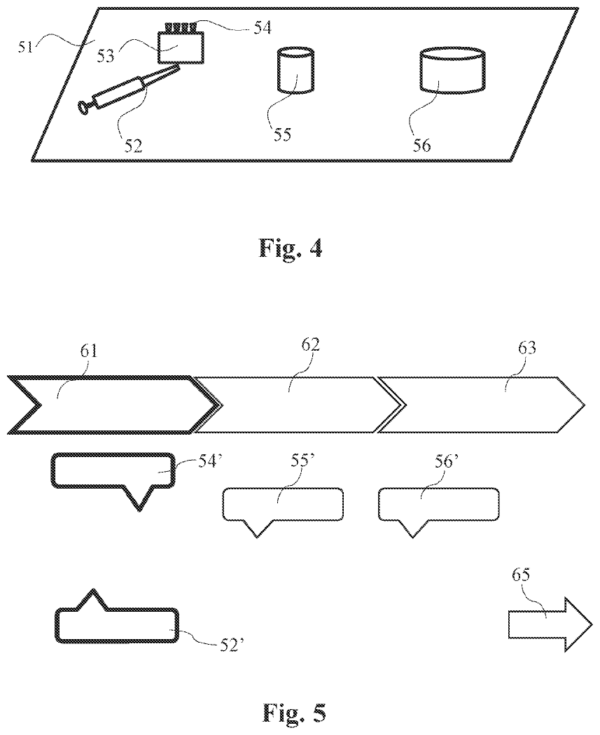

The kind of display in which the real and virtual components are displayed together, i.e. superimposed, is shown in greatly simplified form in FIGS. 4-6: here an example is shown in which a laboratory worker guided by a method according to the invention is to transfer fluid from one container to another container by means of a pipette.

FIG. 4 represents, in greatly simplified form, a laboratory space as seen by a laboratory worker: on a work surface 51 there are arranged, as devices or objects, a pipette 52, a container 53 with fresh pipette tips 54 for the pipette 52, a container 55 containing a fluid, and a target vessel 56. The positions of the individual objects described are known to the data processing system, and the system as it were “knows” which objects have which properties and functions.

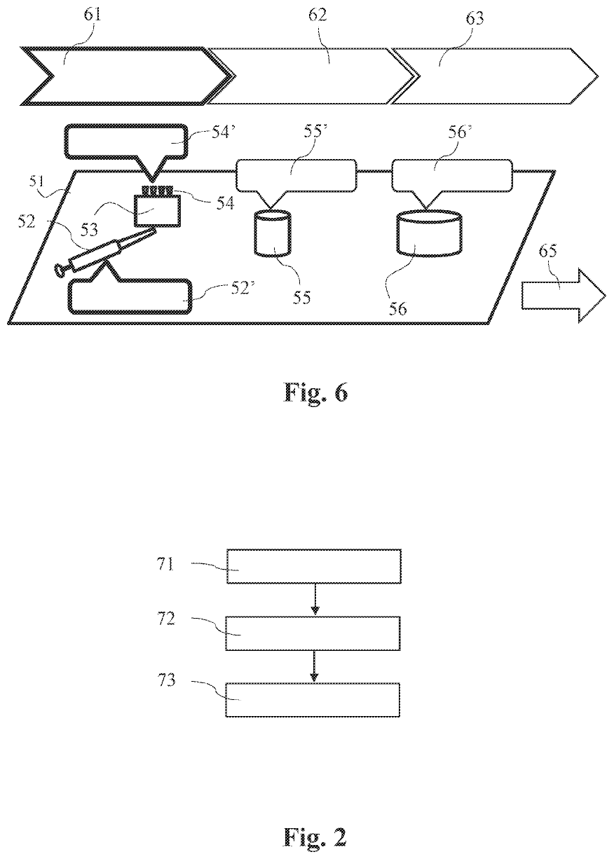

For the execution of the workflow, those objects are then assigned sub-tasks of the chemical workflow in accordance with the properties known for the objects. The software 31 generates therefrom graphic information which, on the one hand, comprises the properties of the objects or their digital twins (pipette 52′, pipette tips 54′, container 55′, container 56′) and, on the other hand, also working steps 61, 62, 63 and any control symbols 65. The graphic information is displayed by the display device 4 (FIG. 5).

FIG. 6 then shows how that graphic information is displayed superimposed on the real objects in the field of vision of the laboratory worker with the aid of an augmented reality apparatus, such as the Microsoft® HoloLens®. Advantageously, just the information relevant to the current working step is highlighted graphically. Here, for example, the first step 61 of the workflow, the picking-up of the pipette 52 by the laboratory worker and mounting of a suitable pipette tip 54, is highlighted in the list of working steps (for example, by different colours, a bolder/less transparent display, etc. symbolized by thicker borders in FIG. 6), while the other, subsequent and not yet current working steps 62, 63 are given less emphasis. The object-specific information for the currently relevant objects (here the pipette 52, the tip container 53 and a pipette tip 54) are accordingly also shown highlighted, so that the laboratory worker immediately sees which objects he is currently to use.

The laboratory worker executes the required working step on the basis of the information thus displayed to him, which information is superimposed on the real objects (here: pick up the pipette 52 and mount a tip 54 from the container 53 on the pipette 52), and confirms or acknowledges the completion of that working step. This can advantageously be done by means of an input to an input apparatus (keyboard, mouse, touchscreen by clicking a control symbol 65 or pressing a key on the input device 6) or, in a further advantageous configuration, by means of voice control. In a further advantageous configuration, the computer 3 or the software 31 running thereon could also itself detect that the working step has been completed, because it detects that a tip 54 has now been mounted on the pipette 52, for example by a comparison of the spatial positions of the objects involved, and then autonomously change to the next task step (here step 62 “aspirate 0.5 ml of fluid from container A”), and again highlight the information then relevant on the display.

For the method according to the invention there are advantageously used sensors, either in the laboratory space 100 itself and/or directly on the wearable recording device 2, in order, for example, to detect images/recordings in visible and non-visible wavelength ranges (UV, IR), and also other forms of radiation (radioactivity), vibrations, acoustic signals, temperature, moisture, concentrations of gas and particles, etc., in the laboratory environment and, advantageously, likewise display them selectively superimposed and record them in the wearable display device 4. This also makes it possible, for example on detection of sensor values that lie outside a range defined by the user, automatically to implement a signal, a warning or a working step introduced ad hoc in response to the out-of-the-ordinary sensor value. For example, on detection of a hazardous gas concentration the laboratory worker can be instructed via the display device 4 to leave the laboratory immediately, and/or he can advantageously even be given precise instructions as to how he must specifically respond to the identified situation.

The method for executing a workflow with the assistance of an augmented reality apparatus described in the above section is currently already used in various corresponding products, both in applications unrelated to chemistry (for example, for displaying assembly directions in industry) or for displaying working instructions for the execution of chemical workflows.

The method according to the invention can also be expanded insofar as the execution phase, in which a workflow is processed on the basis of previously created working instructions, takes place at a different location from the creation of the working instructions. In the execution phase, the workflow is executed by a local laboratory worker, again with the aid of the described recording and display device 200 based on augmented reality technology and on the basis of working instructions 304 which a remote partner has previously created. While the local laboratory worker is carrying out the operation, the remote partner can monitor the workflow and, if need be, correct or customise individual steps. Modern augmented reality devices usually have a camera which records what the wearer of the device is seeing. By means of a network connection between the laboratory (or local laboratory worker) and the remote partner, the latter at all times receives all captured data as well as the video feed of the local laboratory worker in real time and is able to interact with the local laboratory worker, for example via voice communication, and give him instructions. Advantageously, if necessary the remote partner can, however, also even modify the workflow currently being processed, for example by customizing (reprogramming) as yet uncompleted working steps if there is a recognised need. The local laboratory worker then receives the new, modified version presented as working instructions directly by means of his recording and display device.

Advantageously, such remote control can be used by a partner remote from the laboratory even in the case of automated systems and devices, as have become widespread in the automated laboratory environment. For example, a remote partner could create working instructions for an automated laboratory system and cause the latter to execute a workflow by remote control but, analogously to the case with the local laboratory worker, could while so doing make an appropriate control intervention and thus monitor and remotely control the automated laboratory system. This allows a degree of flexibility in the planning and execution of chemical workflows that has not been achieved hitherto.

The execution of the (user-created) workflow and the recording thereof in step 301 is advantageously effected by means of an above-described recording and display device 200, which displays to the laboratory worker suitable options for each working step and allows them to be selected. These include, in particular, working steps, objects and actions and associated parameters.

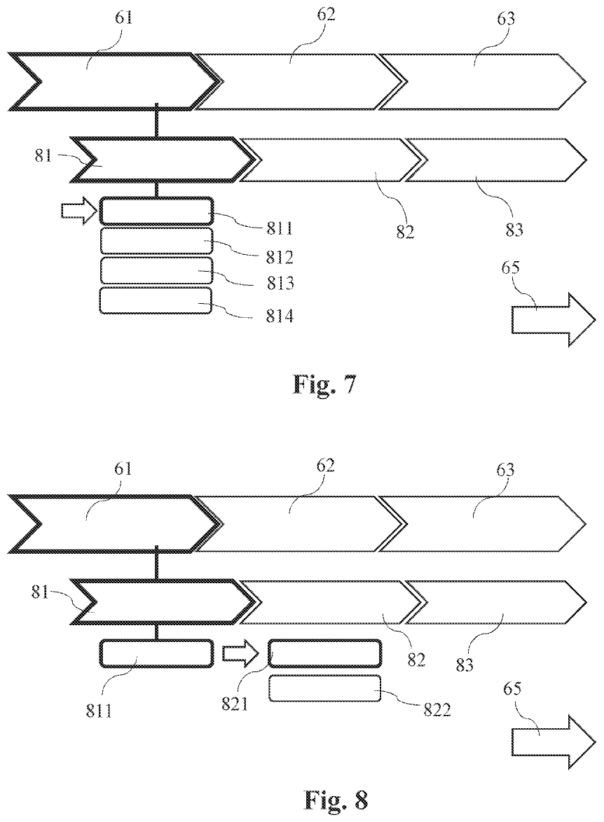

In FIGS. 7 and 8, real objects have been omitted from the drawing and only the information graphics displayed to the laboratory worker by the recording and display device 200 are shown.

FIG. 7 shows a first recording step, wherein suitable options are displayed to the laboratory worker. In this case, by means of an object selection button 81, he can select for a first working step 61 the object with which he wishes to work, for example pipette 811, pipette tip 812, container 813, container 814. By means of an action selection button 82 he can select what he wishes to do with the selected object, and by means of a parameter input button 83 he can input which parameters should then apply. By means of a control device (keyboard, mouse, but advantageously also by visual targeting of a displayed selection field (here 811, 812, 813, 814) or advantageously by means of voice control, he first of all selects the desired object (here pipette 811).

He then selects what is to be done with the pipette (FIG. 8). In the example shown, these are the options “aspirate” 821 or “dispense” 822. Finally, by means of the parameter input button 83, he can input a value, for example the amount he has actually aspirated. The laboratory worker then confirms that input, for example in this case by selection of the control character “Save” 65, which stores the entered inputs in the system under that first working step.

The laboratory worker then proceeds in the same way for the next working steps 62 and 63, again with selection of the desired objects, actions and input of the required parameters, and in that way records the entire workflow that he has executed. That recorded workflow is then subsequently converted by the software 31 into (electronic or digital) working instructions which can either be further used unchanged or after further customisation.

In this case too, it is advantageously possible, as described above, to use additional sensor inputs in order, for example, to record the environmental conditions during the workflow and to supplement the data that is to undergo later evaluation. For example, simultaneously protocolled sensor data (for example measured temperatures, but also thermal images which provide information relating to hot/cold devices) or other physical parameters can be automatically recorded and used further later.

Recorded video images can be abstracted and displayed in abstracted form as working instructions during the execution of subsequent workflows in order to indicate to the user the working steps to be executed. The display is preferably superimposed on the working area visible to the user by means of an augmented reality device.

The method according to the invention also allows an iterative procedure. For example, a first laboratory worker could freely execute and record a workflow in the laboratory and create therefrom working instructions, after which another laboratory worker creates a further workflow based thereon and makes that workflow available to the first laboratory worker, who in turn then executes and records that new workflow and creates new working instructions therefrom. Workflows in the chemical industry can thus be developed further iteratively and chemical production and testing methods and flows can be improved.

1. A method for executing a chemical workflow, wherein the workflow is processed step-by-step manually and/or in an automated manner, wherein while it is being processed, the workflow is recorded by means of a recording device and the recording so created is by means of a computer evaluated and converted into instructions which comprise detailed working instructions for a laboratory worker and/or for at least one automated laboratory device, on the basis of which working instructions the recorded workflow can be repeated manually and/or in an automated manner or, based thereon, a modified workflow can be created.

2. The method according to claim 1, wherein the recording device for recording the workflow is wearable and has augmented reality or mixed reality or virtual reality capabilities.

3. The method according to claim 2, wherein the position and the movement of the recording device within a laboratory space in which the workflow is being executed are recorded.

4. The method according to claim 2, wherein a recording device is used which is equipped with a capability to detect objects and track objects within a laboratory space, there also being recorded positions and/or changes in the positions of objects in the laboratory space.

5. The method according to claim 1, wherein sensor information, such as UV radiation and/or IR radiation and/or radioactive radiation and/or thermal radiation and/or radiation of other wavelengths and/or vibrations and/or contacts are recorded during the processing of the workflow.

6. The method according to claim 5, wherein the sensor information is displayed superimposed on a visual image in a display device and/or presented or displayed via an information device in a laboratory space.

7. The method according to claim 1, wherein information recorded during the workflow is converted into customisable working instructions for a laboratory worker and/or for at least one automated laboratory device, on the basis of which working instructions the recorded workflow or a modified workflow based thereon can be processed.

8. The method according to claim 7, wherein the information which a laboratory worker needs in order to execute the workflow is communicated to the laboratory worker by means of a wearable display device the information being displayed virtually so that it can be associated by the laboratory worker directly with the appropriate working step and/or with the laboratory device used for the working step, the displayed virtual information being superimposed on a real or virtually displayed laboratory space and/or on the laboratory devices located therein.

9. The method according to claim 1, wherein prior to its being executed, the workflow is programmed in digital form and converted into instructions which comprise detailed working instructions for a laboratory worker and/or for at least one automated laboratory device, which working instructions are used for the manual and/or automated execution of the workflow.

10. The method according to claim 9, wherein during the execution of the previously programmed workflow, that workflow is displayed to a laboratory worker executing the workflow as step-by-step directions by means of a wearable display and recording device having augmented reality or mixed reality or virtual reality capabilities, the display and recording device being connected to a computer which controls the workflow.

11. The method according to claim 1, wherein video recordings are created, abstracted and displayed in abstracted form as working instructions superimposed on a working area visible to the laboratory worker in order to indicate to the laboratory worker the working steps that are to be carried out.

12. The method according to claim 10, wherein by means of the display and recording device, individual steps of the working instructions, as well as information relating to laboratory aids, substances and materials to be used and physical conditions and hazards, are displayed directly superimposed on objects visible to the laboratory worker.

13. The method according to claim 10, wherein the display and recording device is equipped with sensors for detecting environmental conditions, and, by means of the wearable display and recording device, environmental conditions detected by the sensors are assigned as physical parameters to the visible objects and, in a converted form understandable for the laboratory worker, displayed and digitally protocolled.

14. The method according to claim 1, wherein a laboratory worker calls up existing working instructions and those working instructions are then converted and sequenced into discrete working steps by an automatic system, after which those discrete working steps are converted into new working instructions or integrated into existing working instructions.

15. The method according to claim 1, wherein physical and/or chemical parameters captured by technical apparatus and devices used during the workflow are digitally recorded.

16. The method according to claim 1, wherein during the execution of the workflow, inputs are entered in order to input parameters that differ from the working instructions or that are to be supplemented, there also being recorded a value specified by the working instructions as well as the input value of the parameter.

17. The method according to claim 1, wherein the chemical workflow is executed by remote control, in which case a remote partner has, via a network connection, access to all information available to a local laboratory worker and/or to at least one automated laboratory device as well as access to an image visually captured by the local laboratory worker and/or by the at least one automated laboratory device and is able to interact with the local laboratory worker and/or with the at least one automated laboratory system in order to direct the local laboratory worker and/or the at least one automated laboratory device and/or to enter inputs himself and/or to operate or control laboratory devices himself.

18. The method according to claim 17, wherein the remote partner effects the creation of the working instructions for the workflow, and the local laboratory worker and/or the at least one automated laboratory device executes the workflow using those working instructions and records that workflow during its execution.
